(19) United States
(12) Patent Application Publication
(10) Pub. No.: US 2015/0054984 A1
(43) Pub. Date: Feb. 26, 2015

(54) IMAGE DISPLAY APPARATUS AND IMAGE DISPLAY METHOD

(71) Applicant: Norihisa Higashikawa, Tokyo (JP)

(72) Inventor: Norihisa Higashikawa, Tokyo (JP)

(73) Assignee: NEC Display Solutions, Ltd.

(21) Appl. No.: 14/384,140

(22) PCT Filed: Mar. 15, 2012
(86) PCT No.: PCT/JP2012/056686

§ 371 Date: Sep. 9, 2014

(51) Int. Cl. H04N 5/232; G06K 9/46; H04N 1/21

(52) U.S. Cl. CPC H04N 5/23293; H04N 1/2129; H04N 5/23241; G06K 9/4604
USPC 348/231.99

(57) ABSTRACT

An image display apparatus includes: an image display unit that displays an image; a memory unit that stores, for each user, setting information related to the image display unit; an image capturing processing unit that generates image data based on a signal captured by an image capturing unit; an image analysis processing unit that extracts, from the image data generated by the image capturing processing unit, a determination image in which personal information for identifying a user is recorded, the image analysis processing unit reading the personal information from the extracted determination image; and a control unit that reads, from the memory unit, setting information corresponding to the user of the personal information read by the image analysis processing unit, the control unit controlling display of the image display unit based on the read setting information.

### TECHNICAL FIELD

The present invention relates to an image display apparatus and an image display method.

### BACKGROUND ART

In an image display apparatus, in a transmissive type display device in particular, electric power consumed by a backlight light source behind the screen accounts for a large proportion of electric power consumption of the entire apparatus. Therefore, as an effective measure for suppressing electric power consumption in an apparatus, there is a method of dimming or turning off the backlight to the greatest possible extent when displaying is not necessary such as when a user is away. As a method of automating this measure there is a commonly used method in which a sensor that uses infrared rays is attached to an apparatus to detect the presence and/or absence of a user (for example, refer to Patent Document 1).

### PRIOR ART DOCUMENT

### Patent Document

[Patent Document 1] Japanese Unexamined Patent Application, First Publication No. 2012-39643

### SUMMARY OF THE INVENTION

### Problem to be Solved by the Invention

However, the technique disclosed in Patent Document 1 has a drawback in that while detection of an object is possible, it is not possible to determine whether or not the detected object is a human, and a specific person cannot be identified among several users.

Moreover, in some cases, use of an apparatus that uses infrared rays is difficult in certain environments such as in an operating room of a hospital and in a semiconductor factory.

Furthermore, settings of an image display apparatus differ for each user in many cases, and particularly in environments such as communal facilities and offices where several users are present for a single apparatus, it is necessary to manually make appropriate changes to apparatus settings every time the user of the apparatus changes. Moreover, in those cases where an administrator centrally manages a plurality of image display apparatuses, information such as used time of an apparatus and currently applied settings can be easily and remotely obtained from conventional apparatuses. However it is difficult in an environment where several users are present for a single apparatus, to obtain data of each user for the apparatus.

The problem point to be solved is that it is not possible to automatically identify a user, and change display related settings according to the identified user.

The present invention takes into consideration the above point with an exemplary object of providing an image display apparatus and an image display method capable of automatically identifying a user of the apparatus and controlling display according to the identified user.

### Means for Solving the Problem

The present invention is an image display apparatus including: an image display unit that displays an image; a memory unit that stores, for each user, setting information related to the image display unit; an image capturing processing unit that generates image data based on a signal captured by an image capturing unit; an image analysis processing unit that extracts, from the image data generated by the image capturing processing unit, a deter urination image in which personal information for identifying a user is recorded, the image analysis processing unit reading the personal information from the extracted determination image; and a control unit that reads, from the memory unit, setting information corresponding to the user of the personal information read by the image analysis processing unit, the control unit controlling display of the image display unit based on the read setting information.

Moreover, the present invention is an image display method comprising the steps of: generating image data based on a signal captured by an image capturing unit, by an image capturing processing unit of an image display device comprising an image display unit that displays an image; extracting, from the generated image data, a determination image in which personal information for identifying a user is recorded, and reading the personal information from the extracted determination image, by an image analysis processing unit of the image display device; and reading setting information corresponding to the user of the read personal information, from a memory unit that stores, for each user, setting information related to the image display unit, and controlling display of the image display unit based on the read setting information, by a control unit of the image display device.

### EFFECT OF THE INVENTION

An image display apparatus of the present invention is capable of automatically identifying a user of the apparatus, and controlling display so as to follow setting information according to the identified user.

### BRIEF DESCRIPTION OF THE DRAWINGS

FIG. 1 is a block diagram showing a configuration of an image display apparatus of one exemplary embodiment of the present invention.

FIG. 2 is a schematic diagram showing a data structure and a data example of a setting data table stored in a ROM in the present exemplary embodiment.

FIG. 3 is a schematic diagram showing a data structure of personal information stored in the ROM in the present exemplary embodiment.

FIG. 4 is a block diagram showing a configuration of an image analysis processing unit in the present exemplary embodiment.

FIG. 5 is a flowchart showing steps of a registration process performed by the image display apparatus of the present exemplary embodiment.

FIG. 6 is an explanatory diagram showing a brief overview of a user detection operation performed by the image display apparatus in the present exemplary embodiment.

FIG. 7 is a flowchart showing steps of a user detection process performed by the image display apparatus in the present exemplary embodiment.

FIG. 8 is a flowchart showing steps of a power saving state release process performed by the image display apparatus in the present exemplary embodiment.

FIG. 9 is a flowchart showing steps of a process performed by the image display apparatus in a case where a determination image could not be read, in the present exemplary embodiment.

FIG. 10 is a flowchart showing steps of a process performed by the image display apparatus of the present exemplary embodiment in a case where a user has not been registered, in the present exemplary embodiment.

FIG. 11 is a schematic diagram showing an example of a case where a management apparatus centrally manages data of each image display apparatus, using the image display apparatus in the present exemplary embodiment.

### EMBODIMENTS FOR CARRYING OUT THE INVENTION

Hereunder, exemplary embodiments of the present invention are described in detail, with reference to the drawings.

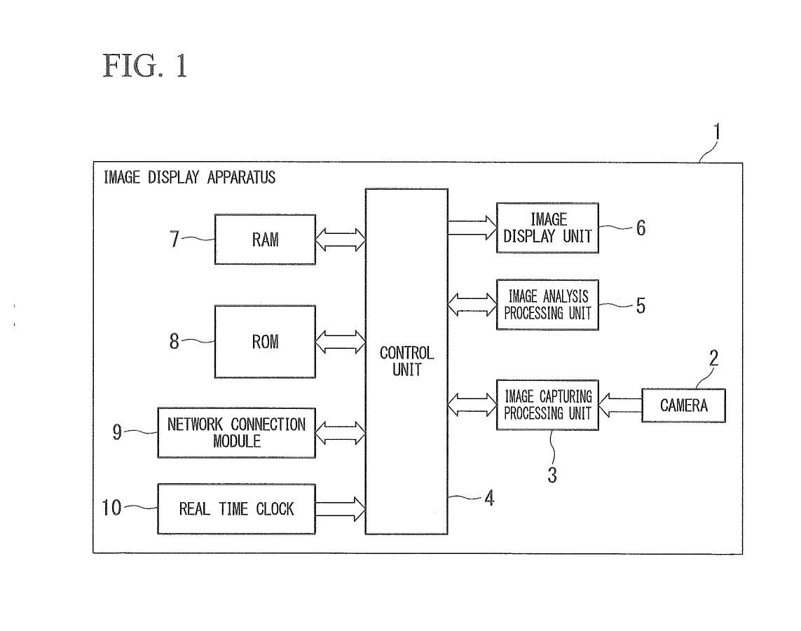

FIG. 1 is a block diagram of one exemplary embodiment of an apparatus of the present invention, being a block diagram showing a configuration of an image display apparatus 1.

The image display apparatus 1 is configured by including a camera 2, an image capturing processing unit 3, a control unit 4, an image analysis processing unit 5, an image display unit 6, a RAM 7, a ROM (storage unit) 8, a network connection module 9 for connecting to a network, and a real time clock (timing unit) 10 that measures time. These components can communicate with each other through a bus.

The camera 2 is an image capturing unit that image-captures a user of the image display apparatus 1. The camera 2 is installed in a manner so that the user of the image display apparatus 1 is positioned within an image capturing range (capturing range) of the camera 2. Moreover, the camera 2 is constantly performing image capturing successively at predetermined intervals. The image display apparatus 1 shown in FIG. 1 includes the camera 2 within the apparatus. However the camera 2 may be externally connected.

The image capturing processing unit 3 generates image data (hereunder referred to as captured image data) based on a captured image signal of the camera 2. The image capturing processing unit 3 is configured by including various processing circuits for converting the signal captured by a circuit that operates the camera 2 or by the camera 2 into digital data, performing various processes on the converted digital data, and generating captured image data captured by the camera.

The image analysis processing unit 5 detects, based on the captured image data generated by the image capturing processing unit 3, whether the user is present or away. When the presence of the user is detected, it extracts a determination image from the captured image data and reads personal information from the extracted determination image. The determination image is an image in which user personal information is recorded, and is, for example, a one-dimensional or two-dimensional bar code, or a specific graphical object. The user personal information is, for example, a piece of information such as ID (identification) for identifying the user. In order to detect whether the user is present or away, the image analysis processing unit 5 first compares the current captured image data with captured image data of the previous stage and detects the user by means of a difference detection method, and it extracts feature points of the detected user. The image analysis processing unit 5 then determines the user as being present while the feature points of the user are present in the captured image data (in the case where feature points have been detected), and determines the user as being away when the feature points of the user are no longer present in the captured image data (in the case where feature points have not been extracted).

The image display unit 6 is a display device such as a liquid crystal display for displaying an image.

The ROM 8 is a nonvolatile memory from which stored data can be read out and into which data can be recorded. The ROM 8 stores setting information of the image display apparatus 1 (image display unit 6) that corresponds to each user, and a setting data table that represents the status of use of the image display apparatus 1. Moreover, the ROM 8 stores personal information for identifying each user. Furthermore, the ROM 8 stores a registered pattern model, which is a piece of image information for extracting a determination image from the captured image data, by means of pattern matching.

The control unit 4 is a central processing unit that performs overall control of the entire image display apparatus 1. For example, the control unit 4 outputs to the image analysis processing unit 5, image data generated by the image capturing processing unit 3. Moreover, the control unit 4 reads from the setting data table, setting information of the image display apparatus 1 corresponding to the personal information read from the captured image data by the image analysis processing unit 5, and changes the setting of the image display apparatus 1 based on the read setting information. Furthermore, the control unit 4 puts the image display apparatus 1 into a power saving state when the user leaves, and releases the power saving state of the image display apparatus 1 when the user is present. The control unit 4 brings the image display apparatus 1 into the power saving state by stopping output to the image display unit 6. That is to say, the image display unit 6 displays no image when in the power saving state. Moreover, the control unit 4 releases the power saving state by resuming output to the image display unit 6. That is to say, the image display unit 6 displays an image when the power saving state is released. Furthermore, when the user is detected as being present, the control unit 4 writes into the setting data table, the current time and date as a most recent time and date at which this user started using the image display apparatus 1, and when the user is detected as being away, the control unit 4 writes into the setting data table, the current time and date as a time and date at which this user last used the image display apparatus 1. Moreover, when the user is detected as being away, the control unit 4 updates the total used time of the apparatus of this user stored in the setting data table, based on the most recent time and date at which this user started using the image display apparatus 1 and the time and date at which this user last used the image display apparatus 1.

The RAM 7 is a temporary storage region for performing operations of the control unit 4.

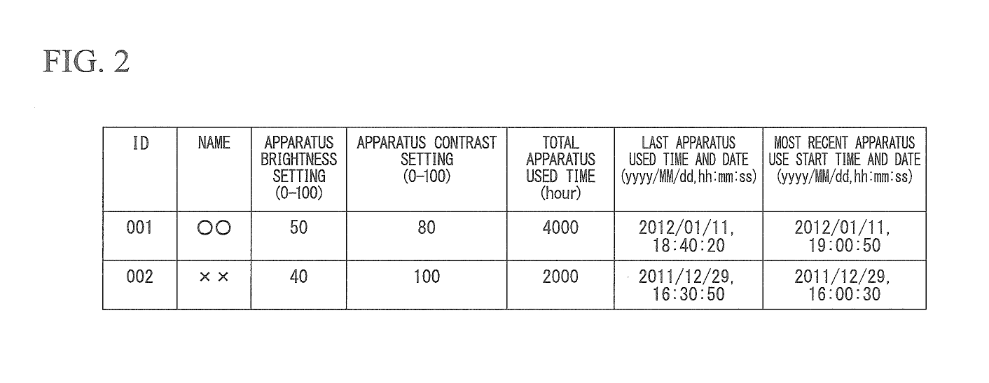

FIG. 2 is a schematic diagram showing a data structure and a data example of the setting data table stored in the ROM 8.

As shown in the figure, the setting data table is two-dimensional tabulated data placed in rows and columns, and it has columns for items including ID, name, apparatus brightness setting, apparatus contrast setting, total apparatus used time, last apparatus used time and date, and most recent apparatus use start time and date. This table has a row for each ID.

An ID is a piece of identification information for identifying each user, and it is, for example, an alphanumeric character sequence or an employee number. A name is a full name or a nickname of the user, or the like. An apparatus brightness setting is a brightness setting value of the image display apparatus 1 that corresponds to the user, and it is set to a value from 0 to 100. An apparatus contrast setting is a contrast setting value of the image display apparatus 1 that corresponds to the user, and it is set to a value from 0 to 100. The apparatus brightness setting and the apparatus contrast setting are setting information related to the image display apparatus 1 (image display unit 6).

A total apparatus used time is a total length of time during which the user used the image display apparatus 1, and its unit is hour. When the user finishes using the image display apparatus 1, the total apparatus used time is updated based on the difference between a last apparatus used time and date and a most recent apparatus use start time and date. Specifically, when the user becomes away, the control unit 4 adds to the total apparatus used time, the difference between the last apparatus used time and date and the most recent apparatus use start time and date. A last apparatus used time and date is a time and date at which the user last used the image display apparatus 1, and it is expressed as year/month/date, hour: minute: second (yyyy/MM/dd, hh:mm:ss). A last apparatus used time and date is recorded when the user finishes using the image display apparatus 1. Specifically, when the user becomes away, the control unit 4 writes the current time and date into the last apparatus used time. A most recent apparatus use start time and date is a most recent time and date at which the user started using the image display apparatus 1, and it is expressed as year/month/date, hour: minute: second (yyyy/MM/dd, hh:mm:ss). A most recent apparatus use start time and date is recorded when the user starts using the image display apparatus 1. Specifically, when the user becomes present, the control unit 4 writes the current time and date into the most recent apparatus use start time and date.

For example, the name of an ID “001” is “OO”, an apparatus brightness setting is “50”, an apparatus contrast setting is “80”, a total apparatus used time is “4000”, a last apparatus used time and date is “2012/01/11, 18:40:20”, and a most recent apparatus use start time and date is “2012/01/11, 19:00:50”. Moreover, the name of an ID “002” is “xx”, an apparatus brightness setting is “40”, an apparatus contrast setting is “100”, a total apparatus used time is “2000”, a last apparatus used time and date is “2011/12/29, 16:30:50”, and a most recent apparatus use start time and date is “2011/12/29, 16:00:30”.

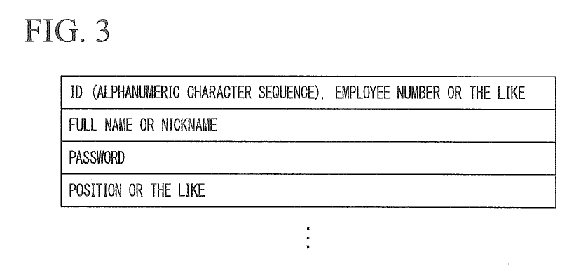

FIG. 3 is a schematic diagram showing a data structure of personal information stored in the ROM 8.

The personal information is a piece of information related to each user, and has items including ID, full name or nickname (name), password, and position or the like.

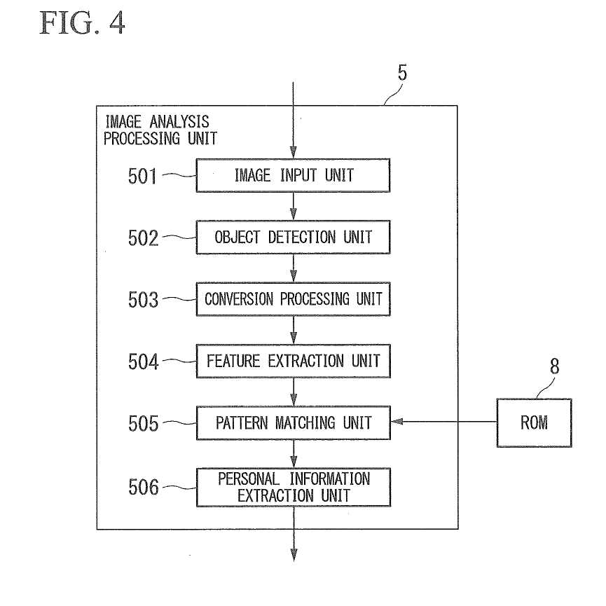

FIG. 4 is a block diagram showing a configuration of the image analysis processing unit 5.

The image analysis processing unit 5 is configured by including an image input unit 501, an object detection unit 502, a conversion processing unit 503, a feature extraction unit 504, a pattern matching unit 505, and a personal information extraction unit 506.

The image input unit 501 takes an input of captured image data generated by the image capturing processing unit 3, and outputs the input captured image data to the object detection unit 502. When the user is away, the object detection unit 502 compares the current captured image data with the captured image data of the previous stage and detects the user by means of a difference detection method. The object detection unit 502, only in a case where the user is detected, outputs to the conversion processing unit 503, the current captured image data and a range where the user is detected in the captured image data (hereunder, referred to as detection range). When the user is present, the object detection unit 502 outputs the input captured image data to the conversion processing unit 503 as it is.

The conversion processing unit 503 performs various conversion processes on the detection range of the input captured image data, and outputs to the feature extraction unit 504, the processed captured image data and the detection range in the captured image data. For example, as the conversion processes, the conversion processing unit 503 performs processes such as image division, noise reduction, level conversion, averaging, and edge detection on the detection range of the captured image data. The feature extraction unit 504 extracts feature points such as density (brightness, contrast, and color tone) and area, from the detection range of the input captured image data. The feature extraction unit 504 treats the extracted feature points as the feature points of the user, and the user will be treated as being present while the feature points of this user are extracted from the subsequent captured image data. Moreover, the feature extraction unit 504 treats the user as being away when the feature points of this user are no longer extracted from the captured image data. Only in a case where features of the user are extracted, the feature extraction unit 504 outputs the input captured image data to the pattern matching unit 505. The pattern matching unit 505 extracts a determination image from the input captured image data, and outputs image data of the extracted determination image (hereunder, referred to as determination image data) to the personal information extraction unit 506. Specifically, the pattern matching unit 505 reads a registered pattern model from the ROM 8, and performs pattern matching on the captured image data against the read registered pattern model, to thereby extract a determination image. The personal information extraction unit 506 reads personal information from the input determination image data and outputs it to the control unit 4.

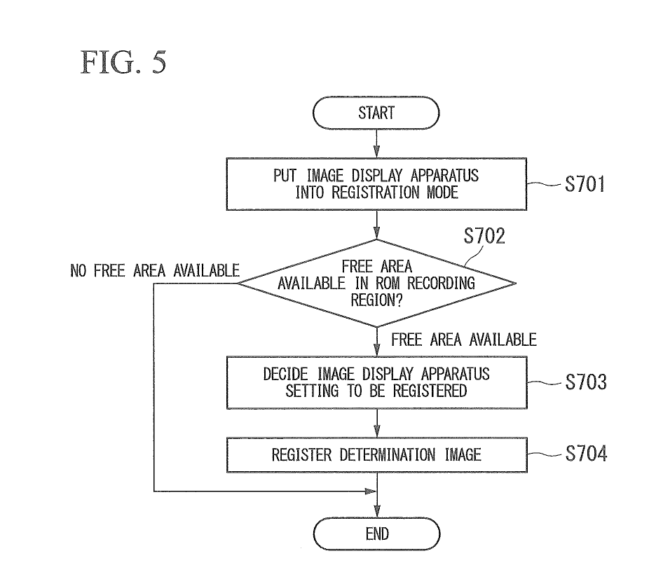

Next, processes performed by the image display apparatus 1 are described, with reference to FIG. 5 through FIG. 10.

First is described a registration process for registering personal information of a user on the image display apparatus 1. FIG. 5 is a flowchart showing steps of the registration process performed by the image display apparatus 1.

Here, the user of the image display apparatus 1 is carrying a card-shaped medium (such as an employee ID card) with a determination image contained therein, in a manner so that the determination image for identifying personal information is positioned within the image capturing range of the camera 2. The determination image for identifying personal information has been preliminarily generated.

First, by means of a user's operation, the control unit 4 sets the image display apparatus 1 to a registration mode for registering a determination image for identifying personal information (step S701). Having set to the registration mode, the control unit 4 determines whether or not there is an empty region in the ROM 8 for recording the personal information (step S702). If there is no empty region in the ROM 8 for recording personal information, then the control unit 4 displays a message on the image display unit 6 acknowledging that personal information cannot be recorded, and it ends the registration mode.

On the other hand, if there is an empty region on the ROM 8, the control unit 4 decides setting information of the image display apparatus 1 to be associated with the personal information (brightness setting and contrast setting) (step S703). Specifically, it receives an input of setting information of the image display apparatus 1, and writes the input setting information into the RAM 7 as setting information to be associated with the personal information. Subsequently, the control unit 4 registers the determination image (step S704). Registration of a determination image is performed while the captured image of the camera 2 is being observed in real time, and it is re-tried until the image display apparatus 1 successfully recognizes the determination image. Specifically, the control unit 4 first activates the camera 2 and starts capturing an image of the user. Next, the image capturing processing unit 3 generates captured image data that has been captured by the camera 2. The image analysis processing unit 5 then extracts determination image data from the generated captured image data, and reads personal information from the extracted determination image data. Here, if determination image data cannot be extracted, the image analysis processing unit 5 extracts determination image data from captured image data of the next stage (extraction is re-tried). Then, the control unit 4 writes the extracted personal information into the ROM 8, and adds to the setting data table of the ROM 8, a record in which ID, name, and decided setting information (brightness setting and contrast setting) are associated.

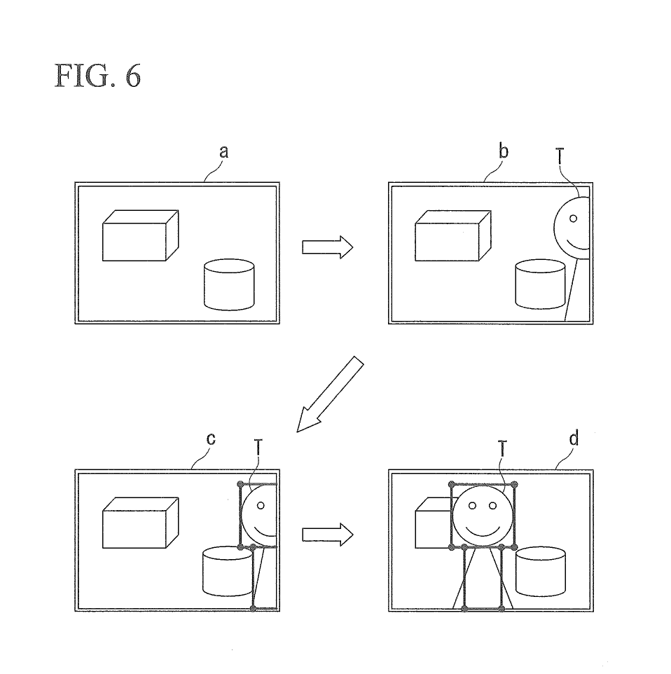

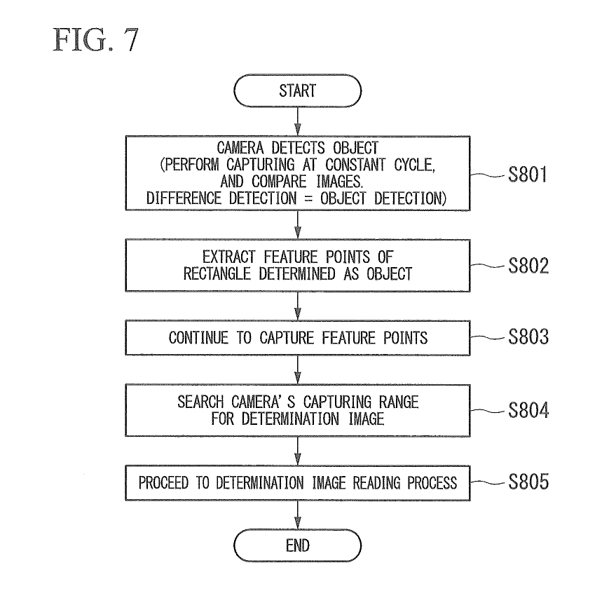

Next is described an operation mode at the time where a user is detected and the state shifts from the power saving state to the normal displaying state (power saving state is released) in the image display apparatus 1 that has been shifted to the power saving state. The control unit 4 shifts the image display apparatus 1 into the power saving state when the user becomes away. First, a upper detection operation performed by the image display apparatus 1 is described, with reference to FIG. 6 and FIG. 7.

FIG. 6 is an explanatory diagram showing a brief overview of a user detection operation performed by the image display apparatus 1.

The camera 2 is constantly image-capturing the surrounding environment of the image display apparatus 1 at constant intervals. FIG. 6 (a) is a captured image that is captured by the camera 2 in a state where a user of the image display apparatus 1 is absent (hereunder, referred to as image A). FIG. 6 (b) is a captured image that is captured by the camera 2 at the following stage of the image A shown in FIG. 6 (a) (hereunder, referred to as image B). FIG. 6 (c) shows feature points extracted in the image B shown in FIG. 6 (b). FIG. 6 (d) is a captured image that is captured by the camera 2 at the following stage of the image B shown in FIG. 6 (b) (hereunder, referred to as image C).

The image analysis processing unit 5 compares the captured image data captured by the camera 2 with the captured image data captured at the previous stage by the camera 2. Specifically, the image analysis processing unit 5 first sets an object detection line in a rectangular range within the captured image. When pixel information of the difference is detected between the two images and a certain amount of the set detection line is hidden, the image analysis processing unit 5 treats a detection of a user as being made. For example, when comparing the image A with the image B, a user T, who is not present in the image A, is present in the image B. Accordingly, an object, which is present in the object detection line in the image A, is now hidden by equal to or more than a certain amount by the user T. As a result, the image analysis processing unit 5 determines the user as being detected in the image B. Next, the image analysis processing unit 5 performs various conversion processes on the range of the image B where the user is present, and it extracts several points from the obtained contour line and treats them as feature points. The image analysis processing unit 5 continues to capture feature points within the captured image, and treats the user as present while the feature points of the user are present within the image capture range of the camera 2. On the other hand, the image analysis processing unit 5 treats the user as having become away if the feature points move to the outside the image capture range.

FIG. 7 is a flowchart showing steps of a user detection process performed by the image display apparatus 1. The process shown in the figure is performed when the image display apparatus 1 is in the power saving state and the user is away.

First, the image analysis processing unit 5 sets an object detection line in a rectangular range within the captured image. When the captured image data that has been captured and the captured image that was captured on the previous stage thereof are compared and pixel information of the difference is detected between the two images as a result of the comparison, and a certain amount of the object detection line is hidden, the image analysis processing unit 5 treats a detection of the user as being made (step S801). Next, the image analysis processing unit 5 performs various conversion processes on the range in the captured image data where the user is present, and it extracts several points from the obtained contour line and treats them as feature points (step S802). The image analysis processing unit 5 treats the user as being present while the featured points are present within the captured image data. While the user is present, the image analysis processing unit 5 continues to extract feature points (step S803), and searches for a determination image in the captured image (step S804). Specifically, the image analysis processing unit 5 reads a registered pattern model from the ROM 8, performs pattern matching on the captured image against the registered pattern model, and reads the image that matches the registered pattern model as a determination image. When a determination image is discovered within the captured image, the image analysis processing unit 5 decodes digital data (personal information) embedded in the determination image (step S805). The subsequent process continues to step S403 of the flowchart described below.

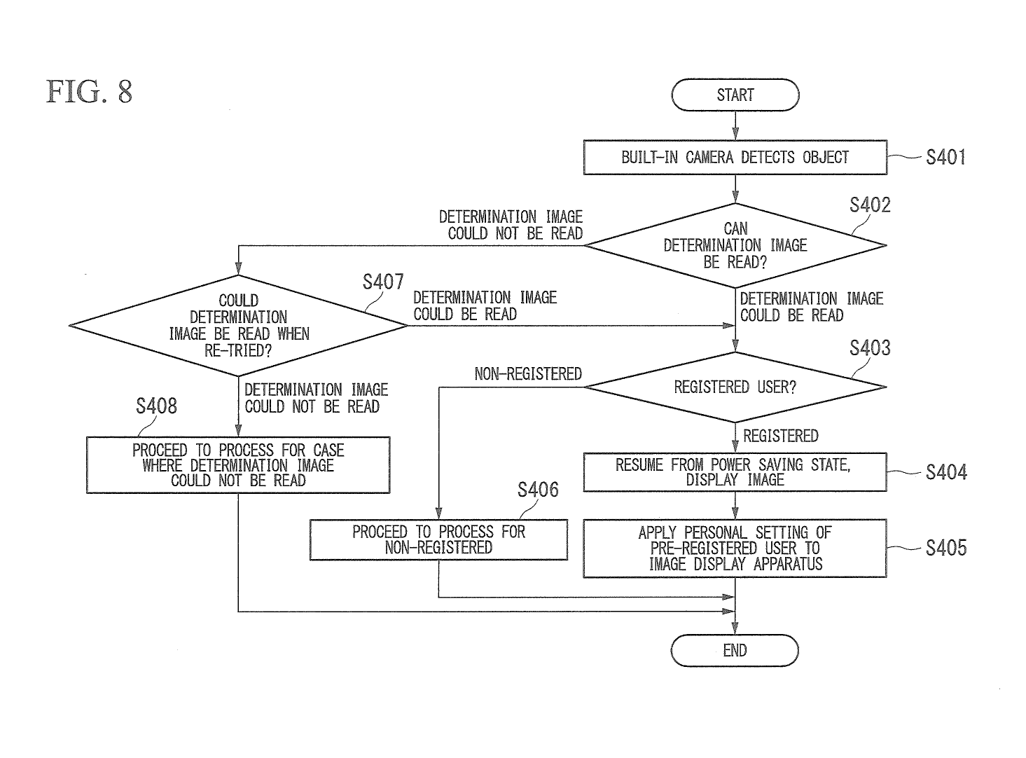

FIG. 8 is a flowchart showing steps of a power saving state releasing process performed by the image display apparatus 1.

First, when a user is positioned within the image capturing range of the camera 2 of the image display apparatus 1, the image analysis processing unit 5 detects the user (step S401). Then, the image analysis processing unit 5 tries to read the determination image from the captured image data and determines whether or not the determination image has been read (step S402). If the determination image could not be read, the image analysis processing unit 5 re-tries to read the determination image (step S407). That is to say, the image analysis processing unit 5 tries to read the determination image from the captured image data of the following stage. If the determination image has been read as a result of the re-try, the process proceeds to step S403, and if the determination image could not be read, the process proceeds to a process for the case where the determination image could not be read (step S408). Detailed description of the process for the case where the determination image could not be read is provided later.

If the determination image has been read, the image analysis processing unit 5 extracts personal information from the determination image and outputs it to the control unit 4. The control unit 4 deter mines whether or not the extracted personal information is that of a registered user (step S403). Specifically, if the same personal information as the extracted personal information is recorded in the ROM 8, the control unit 4 determines the user as a registered user, and if the same personal information as the extracted information is not recorded in the ROM 8, the control unit 4 determines the user as a non-registered user.

If the user is a registered user, the control unit 4 brings the image display apparatus 1 back to the normal state from the power saving state (power saving mode) and displays an image (step S404). The control unit 4 then reads from the setting data table, setting information (brightness setting and contrast setting) corresponding to the ID of the extracted personal information, and applies the read setting information to the image display apparatus 1 (step S405). Moreover, at this time, the control unit 4 writes the current time and date into the most recent apparatus use start time and date that corresponds to the ID of the extracted personal information. On the other hand, if the user is a non-registered user, the control unit 4 shifts the process to a process for the case where the user is a non-registered user (step S406). Detailed description of the process for the case where the user is a non-registered user is provided later.

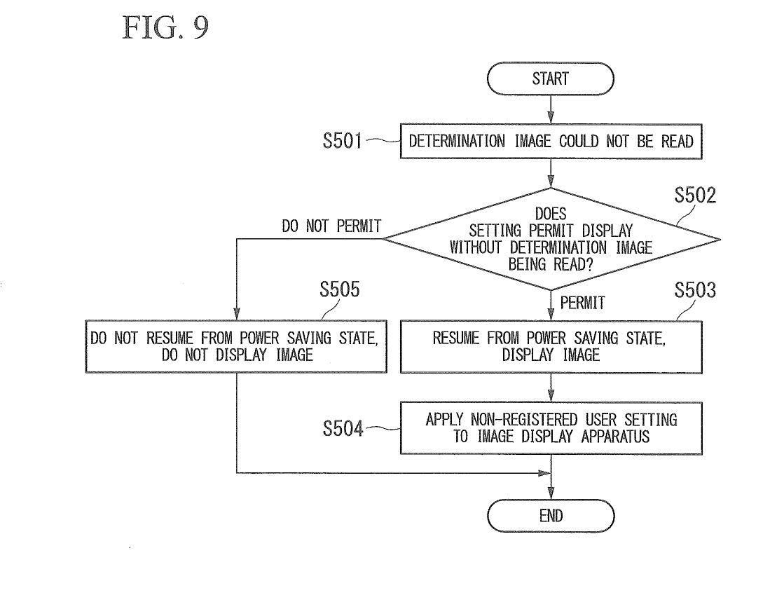

FIG. 9 is a flowchart showing steps of the process performed by the image display apparatus 1 in the case where the determination image could not be read. The process illustrated in this figure corresponds to the step S408 described above.

Here, the ROM 8 preliminarily stores a display permission setting as to whether or not to permit display in the case where the determination image could not be read.

First, the control unit 4 determines that the determination image could not be read (step S501). The control unit 4 then reads from the ROM 8, the display permission setting for the case where the determination image could not be read, and determines whether or not the setting permits display even in the case where the determination image cannot be read (step S502). If the setting permits display even in the case where the determination image cannot be read, the control unit 4 brings the image display apparatus 1 back to the normal state from the power saving state and displays an image (step S503). The control unit 4 then applies a preliminarily set general-purpose display setting to the image display apparatus 1 (step S504). On the other hand, in the case where the setting does not permit display if the determination image could not be read, the control unit 4 does not bring the image display apparatus 1 back from the power saving state (step S505).

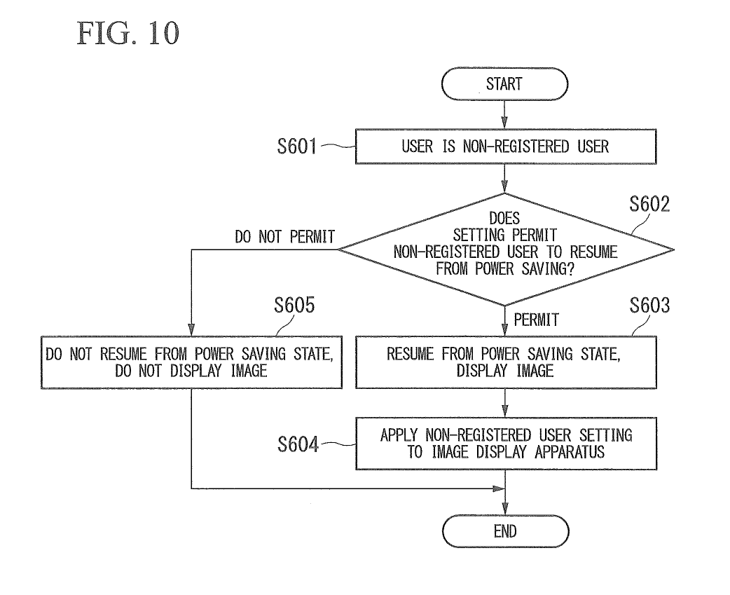

FIG. 10 is a flowchart showing steps of the process performed by the image display apparatus 1 in the case where the user is a non-registered user. The process illustrated in this figure corresponds to the step S406 described above.

Here, the ROM 8 preliminarily stores a display permission setting as to whether or not to permit display in the case where the user is a non-registered user.

First, the control unit 4 determines the user as a non-registered user (step S601). Next, the control unit 4 reads from the ROM 8, the display permission setting for the case where the user is a non-registered user, and determines whether or not the setting permits display even in the case where the user is a non-registered user (step S602). If the setting permits display even in the case where the user is a non-registered user, the control unit 4 brings the image display apparatus 1 back to the normal state from the power saving state and displays an image (step S603). Then, the control unit 4 applies the preliminarily set general-purpose display setting to the image display apparatus 1 (step S604). On the other hand, in the case where the setting does not permit display if the user is not a registered user, the control unit 4 does not bring the image display apparatus 1 back from the power saving state (step S605).

In this manner, according to the present exemplary embodiment, the image display apparatus 1 identifies a user using a determination image. Therefore it does not require complex processes for reading, compared to biometric authentication such as face authentication. Accordingly, it is possible to quickly identify a user in a short period of time without providing a high performance system in the image display apparatus 1. Moreover, since the image display apparatus 1 is capable of automatic user identification, a setting that is preliminarily registered for each user can be automatically applied to the image display apparatus 1, and the state of apparatus use for each individual can be recorded as data.

The data that is recorded in the apparatus as individual's use state includes, for example, the total apparatus used time, the last apparatus used time and date, and the most recent apparatus used time and date of the setting data table. In this example, from the recorded data, it is possible to know the apparatus used time for each user, and in addition, it is possible to find the length of time taken by the user to return after he/she left.

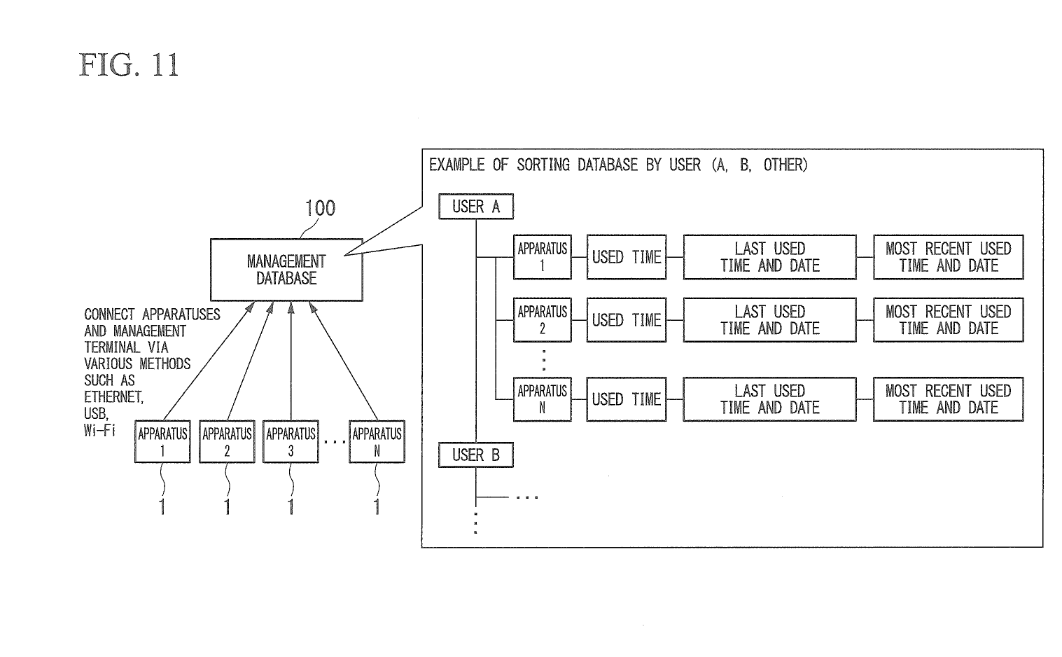

These pieces of information can be managed as a database as shown in FIG. 11 by connecting the image display apparatus 1 to a network and having a system administrator to arbitrarily collect the status of apparatus use. FIG. 11 is a schematic diagram showing an example of a case where a management apparatus centrally manages data of each image display apparatus 1, using the image display apparatus 1. In the example shown in FIG. 11, a management database 100 collects and stores the use status of each image display apparatus 1 for each user (used time, last used time and date, and most recent apparatus used time and date). The management database 100 and the image display apparatus 1 are connected for example by the Internet, a USB (Universal Serial Bus), or Wi-Fi (Wireless Fidelity), and mutual data transmission/reception are possible therebetween. As a result, the administrator can centrally manage each user's use status of each image display apparatus 1.

Moreover, since the image display apparatus 1 is capable of detecting the presence and absence of a user, it is possible to automatically detect user's presence to absence, and automatically shift the apparatus to the power saving state where electric power consumption is suppressed. Moreover, it can detect user's absence to presence, and can resume automatically to the normal state from the power saving state.

Furthermore, the image display apparatus 1 decides as to whether to permit display of the apparatus to resume when the image display apparatus 1 is in the power saving state and a user is detected, by making reference to the apparatus setting according to the situation such as a case where the detected person cannot be determined as a user. Accordingly, depending on the setting, the apparatus may be locked so that it will not resume for any users other than specific users.

Moreover, a program for realizing functions of the image display apparatus 1 (image capturing processing unit 3, control unit 4, and image analysis processing unit 5) in FIG. 1 may be recorded on a computer-readable recording medium, and the program recorded on this recording medium may be read and executed on a computer system to thereby perform the user registration process, the process of shifting to the normal display state from the power saving state, or the process of shifting to the power saving state. The term “computer system” here includes an operating system and hardware such as peripheral devices.

The “computer system” also includes a homepage provision environment (or display environment) in those cases where a WWW system is used.

Furthermore, the term “computer-readable recording medium” refers to a movable medium such as flexible disk, magneto-optical disk, ROM, and CD-ROM, as well as a memory storage device such as a built-in hard disk drive of a computer system. The “computer-readable recording medium” includes one that retains a program for a certain period of time such as a volatile memory inside a computer system serving as a server and/or client. Moreover, the above program may realize some of the functions described above, and further, it may realize the above functions in combination with a program that is preliminarily recorded on a computer system. Moreover, the above program may be preliminarily stored on a predetermined server, and this program may be distributed (downloaded) via a communication line according to a request from another apparatus.

The exemplary embodiment of the present invention has been described in detail with reference to the figures. However, the specific configuration is not limited to this exemplary embodiment, and includes designs that do not depart from the scope of the invention.

For example, the setting information associated with a user is setting such as brightness setting and contrast setting in the exemplary embodiment described above. However, it may be another changeable setting that is unique to the apparatus.

(Supplementary note 1) An image display apparatus including: an image display unit that displays an image; a memory unit that stores, for each user, setting information related to the image display unit; an image capturing processing unit that generates image data based on a signal captured by an image capturing unit; an image analysis processing unit that extracts, from the image data generated by the image capturing processing unit, a determination image in which personal information for identifying a user is recorded, the image analysis processing unit reading the personal information from the extracted determination image; and a control unit that reads, from the memory unit, setting information corresponding to the user of the personal information read by the image analysis processing unit, the control unit controlling display of the image display unit based on the read setting information.

(Supplementary note 2) The image display apparatus according to supplementary note 1, wherein the image capturing unit is installed so as to capture an image of the user of the image display apparatus, and the image analysis processing unit detects whether the user is present or away based on the image data, and extracts a determination image from the image data when presence of the user is detected.

(Supplementary note 3) The image display apparatus according to supplementary note 2, wherein the image capturing unit captures an image at predetermined intervals, and the image analysis processing unit compares current image data with previous image data to thereby detect the user, extracts a feature point of the detected user, treats the user as being present while the feature point of the user is present in an image data captured by the image capturing unit, and treats the user as being away when the feature point of the user is not present in an image data captured by the image capturing unit.

(Supplementary note 4) The image display apparatus according to supplementary note 2 or 3, wherein the control unit puts the image display apparatus into a power saving state when the user leaves, and releases the power saving state of the image display apparatus when the user is present.

(Supplementary note 5) The image display apparatus according to any one of supplementary notes 2 to 4, comprising a timing unit that measures time, wherein the control unit writes into the memory unit a current time and date as a most recent time and date at which the user started using the image display apparatus when the user is detected as being present, and the control unit writes into the memory unit a current time and date as a time and date at which the user last used the image display apparatus when the user is detected as being away.

(Supplementary note 6) The image display apparatus according to supplementary note 5, wherein the memory unit stores for each user, a total used time which is a total amount of time the image display apparatus has been used for, and when a user is detected as being away, the control unit updates the total used time of the user stored in the memory unit, based on a most recent time and date at which the user started using the image display apparatus and a time and date at which the user last used the image display apparatus.

(Supplementary note 7) An image display method including the steps of: generating image data based on a signal captured by an image capturing unit, by an image capturing processing unit of an image display device comprising an image display unit that displays an image; extracting, from the generated image data, a determination image in which personal information for identifying a user is recorded, and reading the personal information from the extracted determination image, by an image analysis processing unit of the image display device; and reading setting information corresponding to the user of the read personal information, from a memory unit that stores, for each user, setting information related to the image display unit, and controlling display of the image display unit based on the read setting information, by a control unit of the image display device.

### REFERENCE SYMBOLS

1 Image display apparatus
2 Camera
3 Image capturing processing unit
4 Control unit
5 Image analysis processing unit
6 Image display unit
7 RAM
8 ROM
9 Network connection module
10 Real time clock
501 Image input unit
502 Object detection unit
503 Conversion processing unit
504 Feature extraction unit
505 Pattern matching unit
506 Personal information extraction unit

1. An image display apparatus comprising:
an image display unit that displays an image;
a memory unit that stores, for each user, setting information related to the image display unit;
an image capturing processing unit that generates image data based on a signal captured by an image capturing unit;
an image analysis processing unit that extracts, from the image data generated by the image capturing processing unit, a determination image in which personal information for identifying a user is recorded, the image analysis processing unit reading the personal information from the extracted determination image; and
a control unit that reads, from the memory unit, setting information corresponding to the user of the personal information read by the image analysis processing unit, the control unit controlling display of the image display unit based on the read setting information.

2. The image display apparatus according to claim 1, wherein
the image capturing unit is installed so as to capture an image of the user of the image display apparatus, and
the image analysis processing unit detects whether the user is present or away based on the image data, and extracts a determination image from the image data when presence of the user is detected.

3. The image display apparatus according to claim 2, wherein
the image capturing unit captures an image at predetermined intervals, and
the image analysis processing unit compares current image data with previous image data to thereby detect the user, extracts a feature point of the detected user, treats the user as being present while the feature point of the user is present in an image data captured by the image capturing unit, and treats the user as being away when the feature point of the user is not present in an image data captured by the image capturing unit.

4. The image display apparatus according to claim 2, wherein the control unit puts the image display apparatus into a power saving state when the user leaves, and releases the power saving state of the image display apparatus when the user is present.

5. The image display apparatus according to claim 2, further comprising a timing unit that measures time,
wherein the control unit writes into the memory unit a current time and date as a most recent time and date at which the user started using the image display apparatus when the user is detected as being present, and the control unit writes into the memory unit a current time and date as a time and date at which the user last used the image display apparatus when the user is detected as being away.

6. The image display apparatus according to claim 5, wherein
the memory unit stores for each user, a total used time which is a total amount of time the image display apparatus has been used for, and
when a user is detected as being away, the control unit updates the total used time of the user stored in the memory unit, based on a most recent time and date at which the user started using the image display apparatus and a time and date at which the user last used the image display apparatus.

7. An image display method comprising:
generating image data based on a signal captured by an image capturing unit, by an image capturing processing unit of an image display device comprising an image display unit that displays an image;
extracting, from the generated image data, a determination image in which personal information for identifying a user is recorded, and reading the personal information from the extracted determination image, by an image analysis processing unit of the image display device; and
reading setting information corresponding to the user of the read personal information, from a memory unit that stores, for each user, setting information related to the image display unit, and controlling display of the image display unit based on the read setting information, by a control unit of the image display device.
